(19) United States
(12) Patent Application Publication
(10) Pub. No.: US 2023/0294670 A1
(43) Pub. Date: Sep. 21, 2023

(54) INTELLIGENT COMPANION APPLICATIONS AND CONTROL SYSTEMS FOR ELECTRIC SCOOTERS

(71) Applicant: GM GLOBAL TECHNOLOGY OPERATIONS LLC, Detroit, MI (US)

(72) Inventors: Christopher L Oesterling, Troy, MI (US); Anthony J. Sumcad, Rochester Hills, MI (US); Russell A Patenaude, Macomb Township, MI (US)

(73) Assignee: GM GLOBAL TECHNOLOGY OPERATIONS LLC, Detroit, MI (US)

(21) Appl. No.: 17/698,355

(22) Filed: Mar. 18, 2022

(51) Int. Cl. B60W 30/08; G01C 21/36

(52) U.S. Cl. CPC B60W 30/08; G01C 21/3605; B60W 2300/365; B60W 2510/06; B60W 2554/4041

(57) ABSTRACT

Presented are adaptive operator assistance systems for motor-assisted manually powered (MMP) vehicles, methods for making/using such systems, and electric scooters equipped with such systems. A method of operating an MMP vehicle using a handheld mobile computing device (MCD) includes the handheld MCD receiving path plan data for the MMP vehicle and then receiving, based on this path plan data, MMP-specific ambient data that is aligned with the vehicle's present location and contains surrounding environment data particular to the MMP vehicle. A wireless location device of the handheld MCD tracks the MMP vehicle's real-time location, and a sensing device of the handheld MCD detects MMP-specific threat data that is aligned with the vehicle's real-time location and contains user danger data particular to the MMP vehicle. The handheld MCD then commands a resident subsystem of the MMP vehicle to execute a control operation based on the MMP-specific ambient data and/or threat data.

### INTRODUCTION

The present disclosure relates generally to motor-assisted, manually powered vehicles. More specifically, aspects of this disclosure relate to vehicle operator assistance systems and control logic for electric bicycles and kick-type electric scooters.

Many vehicles that have traditionally been powered by the vehicle's operator—be it hand-powered or foot-powered designs—may now be originally equipped with or retrofit to include a traction motor for assisting with propelling the vehicle. The traction motor, which may take on the form of an internal combustion engine (ICE) or an electric motor, generally propels the vehicle in either an assisted or an unassisted capacity, i.e., with or without manually generated tractive force. For instance, a standup-type electric scooter (colloquially referred to as an “electric kick scooter” or “E-scooter”) is equipped with an on-board electric motor for providing supplemental tractive torque that assists or “boosts” a rider's foot-generated tractive power. The traction motor operates alone or in conjunction with a power transmission to rotate a driven member of the E-scooter, such as a wheel hub or axle shaft. Assist torque from the motor may be automatically or selectively delivered to the driven member, e.g., when the rider negotiates a road surface with a pronounced gradient along a travel route. In this manner, the rider's perceived manual effort needed to propel the vehicle may be reduced when riding an E-scooter relative to the perceived effort on a standard scooter lacking an electrical assist (e-assist) function.

### SUMMARY

Presented herein are adaptive operator assistance systems with attendant control logic for motor-assisted manually powered (MMP) vehicles, methods for constructing and methods for operating such systems, and intelligent electric scooters equipped with such systems. By way of example, there are disclosed “smart” companion applications and control systems for assisting and protecting operators of MMP vehicles. A dedicated mobile application provisions both system-automated and operator-activated protection and security features that are specific to users of MMP vehicles. The application may leverage crowd-sourced data, user-specific data, and open-map data, e.g., for identifying sidewalks, roads, and other pathways navigable via an MMP vehicle. Real-time data for weather, pathway hazards (e.g., chained/fenced animals, damaged/unsafe sidewalks, etc.), and timed systems (e.g., sprinklers) may also be retrieved for the MMP vehicle. Using the smartphone's existing hardware as an active sensor farm and user-feedback interface, the companion application may automatically detect MMP vehicle collisions, geolocate and track MMP vehicle movement, and sense upcoming or oncoming hazards. For a detected collision or other distress scenario, the system may be enabled to automatically alert a first responder, dispatch roadside assistance, share location data with interested parties, etc. The companion application also provisions real-time terrain hazard warnings, overtaking vehicle notifications, and scooter-specific distraction warnings.

Aspects of this disclosure are directed to adaptable control techniques, system control logic, and dedicated mobile software applications for governing operation of an MMP vehicle. In an example, a method is presented for operating a motor-assisted, manually powered vehicle using a handheld mobile computing device (MCD). This representative method includes, in any order and in any combination with any of the above and below disclosed options and features: receiving, e.g., via the handheld MCD using a resident GPS transceiver or cellular trilateration and a user HMI, path plan data including a vehicle origin for the MMP vehicle; determining, e.g., via the handheld MCD based on the received path plan data, MMP-specific ambient data that is aligned with the vehicle's origin and contains one or more predefined sets of surrounding environment data particular to a species of the MMP vehicle (e.g., e-bike vs. e-scooter vs. e-skateboard); tracking, e.g., via a wireless location device resident to the handheld MCD, a real-time vehicle location of the MMP vehicle while traversing from the vehicle origin to a vehicle destination; detecting, e.g., via one or more sensing devices resident to the handheld MCD, MMP-specific threat data that is aligned with the vehicle's real-time location and contains one or more predefined sets of user danger data particular to the MMP vehicle's species; and transmitting, e.g., via the handheld MCD to one or more vehicle subsystems resident to the MMP vehicle, one or more command signals to execute one or more control operations based on the MMP-specific ambient data, the MMP specific threat data, or both.

Additional aspects of this disclosure are directed to intelligent MMP vehicles that piggyback with portable MCDs for provisioning vehicle operator assistance. As used herein, the terms “MMP vehicle” and “vehicle”, including permutations thereof, may be used interchangeably and synonymously to reference any relevant motorized vehicle platform that is powered predominantly by a human, such as motor-assisted scooters, cycles, carts, skateboards, strollers, wheelchairs, etc. In an example, a motor-assisted, manually powered vehicle includes a vehicle body with a passenger platform that supports thereon a standing or seated user, multiple road wheels mounted to the vehicle body (e.g., via forks, hubs, axles, etc.), and other standard original equipment. A prime mover, such as an electric traction motor and/or an engine assembly, is mounted to the vehicle body and operable to selectively drive one or more of the road wheels—independent of or in conjunction with manual propulsion from the standing user—to propel the vehicle.

Continuing with the discussion of the preceding example, the MMP vehicle is also equipped with a resident vehicle controller that is attached to the vehicle body and configured to communicate with a handheld mobile computing device carried by the standing user. A dedicated mobile software application (“companion app”) is executable on the handheld MCD and programmed to receive path plan data for the MMP vehicle and then determine, based on this path plan data, MMP-specific ambient data that is aligned with the vehicle's present location or selected start location (collectively “origin”). The ambient data contains one or more predefined sets of surrounding environment data that is tailored to the type/species of the MMP vehicle. The companion app then tracks a real-time location of the MMP vehicle using a wireless location device of the handheld MCD, and then detects MMP-specific threat data using a sensing device of the handheld MCD. This threat data is aligned with the vehicle's real-time location and contains one or more predefined sets of user danger data that is tailored to the MMP vehicle type/species. The companion app then transmits a command signal to the vehicle controller to command a resident vehicle subsystem to execute a control operation based on the MMP-specific ambient data and/or threat data.

Aspects of this disclosure are also directed to computer-readable media (CRM) for governing operation of a motor-assisted, manually powered vehicle. In an example, non-transitory CRM stores instructions executable by one or more processors of a handheld mobile computing device. These instructions, when executed by the processor(s), cause the handheld MCD to perform operations, including: receiving path plan data including a vehicle origin for the MMP vehicle; determining, based on the received path plan data, MMP-specific ambient data aligned with the vehicle origin and containing a predefined set of surrounding environment data particular to a vehicle species of the MMP vehicle; tracking, using a wireless location device of the handheld MCD, a real-time vehicle location of the MMP vehicle while traversing from the vehicle origin to a vehicle destination; detecting, using a sensing device of the handheld MCD, MMP-specific threat data aligned with the real-time vehicle location and containing a predefined set of user danger data particular to the vehicle species of the MMP vehicle; and transmitting a command signal to a resident vehicle subsystem of the MMP vehicle to execute a control operation based on the MMP-specific ambient data and/or the MMP specific threat data.

For any of the disclosed vehicles, methods, and CRM, the handheld MCD may also determine a vehicle subspecies of the MMP vehicle (e.g., standard, foldable, stunt, big wheel, etc.), and then modify the control operation based on the MMP vehicle's subspecies. In this regard, the handheld MCD may also determine a skill level specific to the current operator of the MMP vehicle, and then modify the control operation based on the operator's determined skill level. As yet a further option, the handheld MCD may also receive one or more user-selected preferences input by the current operator of the MMP vehicle, and then modify the control operation based on the user-selected preference(s).

For any of the disclosed vehicles, methods, and CRM, the sensing device of the handheld MCD may include a video camera and/or a proximity sensor operable to detect moving targets. In this example, one of the predefined sets of user danger data may include target object data that is indicative of a motor vehicle that is oncoming or overtaking the MMP vehicle. The handheld MCD may transmit a notification to a vehicle subsystem of the motor vehicle (e.g., a center-stack telematics unit) that alerts the driver to the presence of the MMP vehicle relative to the motor vehicle. The MCD may also output an audible or tactile alert to notify the MMP vehicle operator of the approaching motor vehicle.

For any of the disclosed vehicles, methods, and CRM, the path plan data may also include a predicted path for the MMP vehicle to traverse from the vehicle origin to the vehicle destination. In this instance, one of the predefined sets of surrounding environment data may include one or more memory-stored hazards located on the predicted path. Depending on the number/type of hazards, the handheld MCD may identify and present to the operator an alternate route for traversing from the vehicle origin to the destination.

For any of the disclosed vehicles, methods, and CRM, the resident vehicle subsystem may include an audio device, a video device, and/or a tactile device each mounted to the vehicle body of the MMP vehicle. In this instance, the control operation includes one or more audible, visual, and/or tactile notifications. In the same vein, an audio, video, and/or tactile device of the handheld MCD may output an audible, visual, and/or tactile alert to the user of the MMP vehicle based on the MMP-specific ambient data/threat data. In some implementations, the handheld MCD is a smartphone, and the sensing device includes an accelerometer, a gyroscope, a proximity sensor, a magnetometer, a temperature sensor, a global positioning system (GPS) transceiver, and/or a light sensor. moreover, the vehicle species of the MMP vehicle may include an electric pedal cycle, an electric standing kick scooter, an electric skateboard, etc., each of which is equipped with a motor that generates intermittent assist torque to propel the MMP vehicle.

For any of the disclosed vehicles, methods, and CRM, the one or more predefined sets of surrounding environment data of the MMP-specific ambient data may include: hazards data indicative of path hazards proximal the vehicle origin, weather data indicative of ambient weather conditions proximal the vehicle origin, and/or timed systems data indicative of home-automated irrigation, lighting, and/or door systems proximal the vehicle origin. The one or more predefined sets of user danger data of the MMP-specific threat data may include: hazards data indicative of detected path hazards proximal the real-time vehicle location, approaching vehicles data indicative of a detected motor vehicle approaching the real-time vehicle location, and/or distractions data indicative of a detected one of a plurality of preset user distractions proximal the real-time vehicle location.

The above Summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIGS. 1 and 2 are front and rear perspective-view illustrations, respectively, of a representative motor-assisted, manually powered (MMP) vehicle having adaptable operator assistance capabilities in accordance with aspects of the present disclosure.

FIG. 3 is a schematic diagram of a representative intelligent operator companion system and process workflow for assisting operators of MMP vehicles in accord with aspects of the disclosed concepts.

FIG. 4 is a flowchart illustrating a representative intelligent companion algorithm for assisting operators of MMP vehicles, which may correspond to memory-stored instructions that are executable by a resident or remote controller, control-logic circuit, programmable control unit, or other integrated circuit (IC) device or network of devices in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

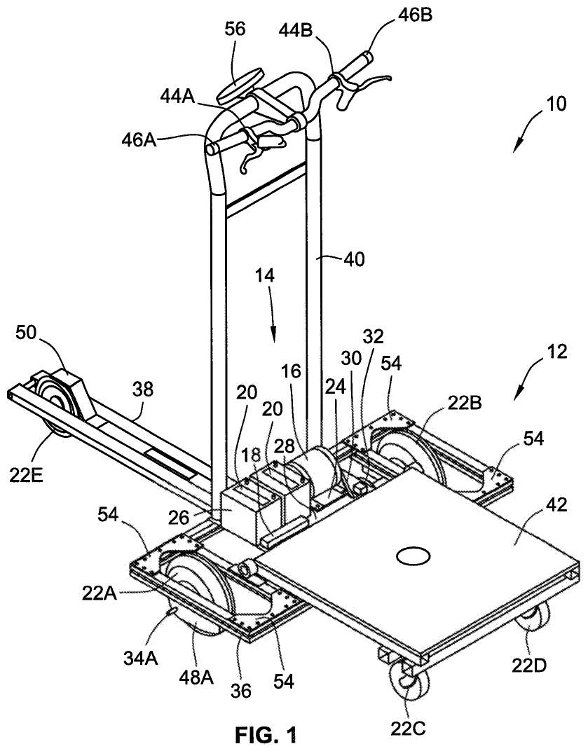

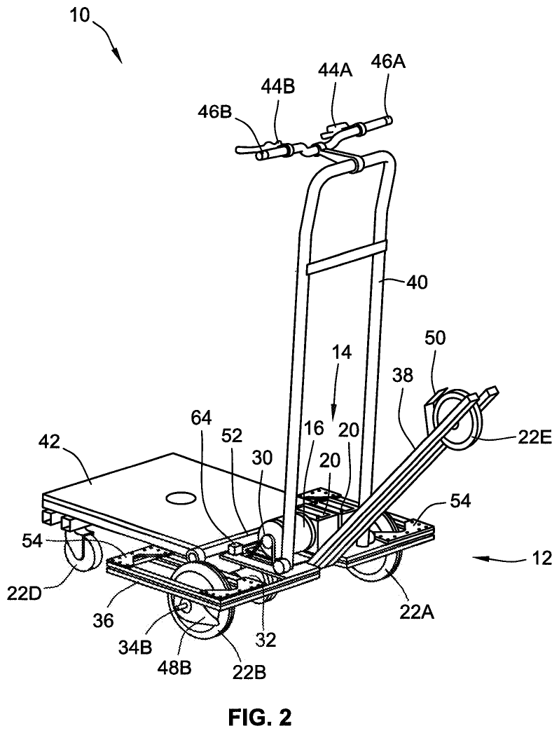

Referring now to the drawings, wherein like reference numbers refer to like features throughout the several views, there is shown in FIGS. 1 and 2 a representative motor-assisted, manually powered (MMP) vehicle, which is designated generally at 10 and portrayed herein for purposes of discussion as a standup-type electric kick scooter. The illustrated MMP vehicle 10—also referred to herein as “manually powered vehicle” or “vehicle” for brevity—is merely an exemplary application with which novel aspects of this disclosure may be practiced. In the same vein, incorporation of the present concepts into the illustrated system architecture discussed below should also be appreciated as a representative implementation of the novel features disclosed herein. As such, it will be understood that aspects and features of this disclosure may be applied to other vehicle operator assistance systems, may be carried out by a variety of different handheld mobile computing devices (MCD), and may be implemented for any logically relevant type of manually powered vehicle. For instance, while described as a cargo-carrying e-scooter that wirelessly piggybacks with a smartphone to provide operator assistance, disclosed features may be similarly applied to e-bike, e-skateboard, and other e-scooter configurations that connect wirelessly or by-wire with other handheld cellular-enabled computing devices, including tablet computers, smartwatches, personal digital assistants, etc.

MMP vehicle 10 of FIG. 1 is originally equipped with a propulsion assist system 14 for aiding a vehicle operator who is manually propelling the vehicle 10. The propulsion assist system 14 is generally composed of a traction motor 16 that communicates with and, at the same time, is governed by a resident vehicle controller 18, both of which are securely mounted onto a rigid body or chassis 12 of the MMP vehicle 10. According to the illustrated example, the traction motor 16 is a transverse-mounted, multi-phase electric motor/generator unit (MGU) that is powered by a pair of rechargeable traction battery modules 20. These traction battery modules 20 store energy that is used to power the onboard vehicle electronics and the MGU 16 for selectively driving right-hand (starboard) and left-hand (port) drive wheel units 22A and 22B, respectively. For at least some applications, the traction motor 16 and battery packs 20 are respectively affixed by a mounting bracket 24 and battery cases 26 to a mounting plate 28 of the vehicle chassis 12. An optional outer housing (not shown for ease of reference to the underlying components) may cover and protect the motor 16, battery modules 20, and any attendant peripheral hardware. Traction battery modules 20 may take on many suitable configurations, including a stack of lead-acid, lithium-ion, or lithium-polymer cells, or other applicable type of high-voltage, high ampere-hour capacity, direct current (DC) electric battery.

To impart motive power to the vehicle 10, the traction motor 16 is drivingly coupled to the two drive wheel units 22A, 22B through a suitable power transmission, such as a belt-drive or a chain-drive transmission 30. The vehicle's final drive system employs a split-power differential gear train 32 that apportions motor-generated torque and power between the wheel units 22A, 22B. Each of two axle shafts 34A (FIG. 1) and 34B (FIG. 2) is operatively connected at one end thereof, e.g., via splined engagement, to the differential 32 and at the opposite end thereof, e.g., via a shaft coupler, to a respective one of the wheel units 22A, 22B. Although shown as a mid-mount, transverse motor layout, the traction motor 16 may be reoriented or repositioned to other locations of the chassis 12 and drivingly connected to any or all of the drive wheels 22A-22E, e.g., to provide a front-wheel drive (FWD), rear-wheel drive (RWD), four-wheel drive (4WD), or all-wheel drive (AWD) drivetrain configuration. It is further envisioned that the vehicle 10 employs other prime movers for supplemental propulsion, including an internal combustion engine or a hybrid powertrain that employs both an electric machine and a combustion engine.

With continuing reference to FIG. 1, the traction motor 16 is electrically connected to and energized by the traction battery modules 20 to propel the vehicle 10 in either an unassisted “motor-only” propulsion mode or an assisted “motor-rider” propulsion mode. Resident vehicle controller 18 is programmed to receive and process various user-input signals, sensor signals, and wireless data exchanges, and respond to these inputs by modulating output of the traction motor 16 via one or more motor control signals. During the assisted operating mode, the traction motor 16 outputs an “e-assist” torque at a level sufficient to augment or “boost” user-generated drive wheel torque. Conversely, when functioning in an unassisted operating mode, the traction motor 16 outputs a motive torque that is sufficient to temporarily propel the vehicle 10 without a kicking-gait motion from the rider to push the vehicle 10. In this manner, the vehicle controller 18 may automatically allocate electrical energy from the battery modules 20 to the motor 16 in real-time and, thus, reserve e-assist functions in real-time while the vehicle 10 negotiates a travel route.

Electric scooter 10 of FIG. 1 may take on a variety of different scooter, cart, and hybrid-body configurations that incorporate a cargo bed, basket, bin, or other loadbearing structure for transporting cargo. By way of example, the representative vehicle 10 is portrayed as a five-wheel electric cargo scooter with a vehicle body or chassis 12 that is fabricated with a box-type support frame 36, a wheeled scooter deck 38, an upright handlebar set 40, and a forward cargo bed 42. Scooter deck 38 projects rearwardly from the box-type frame 36 for supporting thereon a standing rider (not shown). In accord with the illustrated example, scooter deck 38 of FIGS. 1 and 2 is shown movably mounted to the frame 36 to transition back-and-forth between a generally horizontal “deployed” position and a generally vertical “stowed” position. MMP vehicle 10 may also utilize a pivoting coupler joint that allows the scooter deck 38 to pivot in both a pitching motion, e.g., about a transverse axis, as well as a yawing motion, e.g., about a vertical axis. Frame 36, scooter deck 38, handlebar set 40, and cargo bed 42 may each be manufactured from a rigid metallic material, such as 80/20 aluminum, a high-strength polymer, such as rigid polyvinyl chloride (RPVC), or a combination of suitably rigid, rust resistant materials.

Handlebar set 40 projects upwardly from the box-type support frame 36 and allows the rider to manually control the heading and directional changes of the vehicle 10. Right-hand and left-hand brake lever assemblies 44A and 44B, respectively, are mounted on the handlebar set 40 adjacent respective handle grips 46A and 46B. These brake lever assemblies 44A, 44B allow the user to selectively slow and stop the vehicle 10 by actuating right-side and left-side drum brake assemblies 48A (FIG. 1) and 48B (FIG. 2). An optional foot brake 50 attached in proximity to a rearward end of the scooter deck 38 is designed to be pressed down by a user's foot to frictionally engage and slow the rear wheel unit 22E.

Located at the front of the MMP vehicle 10, forward cargo bed 42 provides a rigid surface for seating thereon and supporting a cargo payload. Although not shown, the cargo bed 42 may incorporate guard rails, a basket, or a container to provide additional retention and protection while transporting cargo placed on the vehicle 10. A slide bracket 52 mechanically couples the rearward end of the cargo bed 42 to the frame 36 and allows for adjustable repositioning of the bed 42. Optional support plates 54 may be mounted to the frame 36 fore and aft of the left-hand and right-hand ground wheel units 22A and 22B.

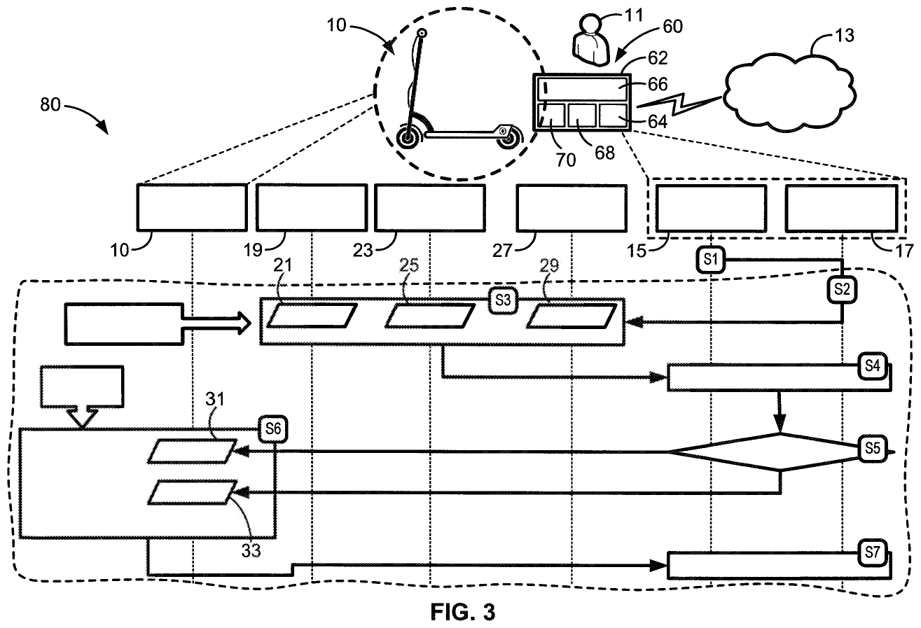

E-assist capabilities may be selectively provided by the traction motor 16 in response to motor control signals from the vehicle controller 18. Real-time interface of an operator 11 (FIG. 3) with the resident vehicle controller 18 may be facilitated via a human machine interface (HMI) (e.g., touchscreen interactive display device 56) that is mounted onto the handlebar set 40. Vehicle controller 18 may also exchange data with a fitness tracker device, such as a wearable electronic monitoring device (not shown), that measures heart rate, caloric expenditure, perspiration, pedal rate, or any combination of health-related and activity-related parameters of the operator 11. The operator 11 may also use a cellular-enabled smartphone, watch, tablet computer, or other handheld MCD 60 (FIG. 3) to provide additional inputs to the vehicle controller 18, such as real-time vehicle location tracking, user preferences and milestones, historical assist level data, etc. Resident vehicle controller 18, wearable electronic device, and handheld MCD 60 may communicate by-wire or wirelessly with one another and with one or more remote computing nodes, such as a backend or middleware server computing node a host cloud computing service 13. Long-range communication capabilities with remote, off-board networked devices may be provided via a cellular chipset/component, a wireless modem, a navigation and location chipset/component (e.g., GPS transceiver), a radio transmitter, etc. Short-range wireless communication between devices may be enabled via a Bluetooth® device, a near field communications (NFC) transceiver, an infrared emitter and photo-diode receiver, or any suitable means of wireless communication.

As indicated above, resident vehicle controller 18 is constructed and programmed to govern, among other things, operation of the traction motor 16, display device 56, etc. Controller, control unit, control module, module, microprocessor, processor, and permutations thereof may be used interchangeably and synonymously to reference any one or various combinations of one or more of logic circuits, Application Specific Integrated Circuit(s) (ASIC), integrated circuit device(s), central processing unit(s) (e.g., microprocessor(s)), and may include appropriate signal conditioning, input/output, and buffer circuitry, and related components to provide herein described functionality. Associated memory and storage (e.g., read only, programmable read only, random access, hard drive, etc.)), whether resident, remote, or a combination of both, stores software, firmware programs, routines, instructions, and/or data retrievable by a controller.

Software, firmware, programs, instructions, routines, code, algorithms and similar terms may mean any controller executable instruction sets including calibrations and look-up tables. The controller may be programmed with a set of control routines executed to provide desired functions. Control routines are executed, such as by a central processing unit or a networked controller or control modules, and are operable to monitor inputs from sensing devices and other networked control modules, to execute control and diagnostic routines for controlling operation of devices and actuators. Routines may be executed in real-time, near real-time, continuously, systematically, sporadically and/or at regular intervals, for example, each 100 microseconds or 10 or 50 milliseconds, etc., during ongoing vehicle use or operation. Alternatively, routines may be executed in response to occurrence of any one of a set of calibrated events during operation of the vehicle 10.

Turning next to FIG. 3, there is shown a schematic diagram of a representative intelligent operator companion system 80 for assisting operators of MMP vehicles. In this example, a vehicle operator or rider 11 wirelessly communicates with an MMP vehicle, namely electric kick scooter (e-scooter) 10, using a handheld MCD, such as a cellular-enabled handheld smartphone 60. Smartphone 60 is fabricated with a protective casing 62 that houses one or more input devices 64, such as a keyboard, buttons, button panel, a track ball, a trackpad, a microphone, a camera, voice and/or gesture recognition software and hardware. Combined input/output functionality may be provided by a touchscreen display device 66, which may be in the nature of a high-resolution, liquid crystal display (LCD) panel or an organic light emitting diode (OLED) display. For device output, the smartphone 60 employs one or more output devices 68, such as audio speaker components, haptic transducers, user-accessible ports (e.g., an audio output jack for headphones, a video headset jack, etc.), and other conventional I/O devices and ports. The primary display device 66 can be configured to display aspects of a guardian scooter companion engine, which can take on the form of a dedicated mobile software application (or “app”), as well as other tangential features, functions and information, such as text messaging, emails, alerts, etc. In some embodiments, the smartphone 60 can also include a variety of sensing, tracking, and measurement devices 70, such as a wireless location device (e.g., GPS transceiver), an accelerometer, a digital camera, a proximity sensor, a gyroscope, a magnetometer, a temperature sensor, a light sensor, etc. By handheld, it is meant that a mobile computing device can be comfortably held in the hand or hands of an adult human and weighs a couple ounces to a few pounds.

For enhanced operation of the e-scooter 10, the rider 11 may activate and interface with a dedicated mobile software application (“companion app”) 15 that is executable on the handheld MCD 60, as indicated at control operation (S1) of the process workflow in FIG. 3. Coded as a multifunction software program, the companion app 15 may provision, among other things, system-automated and operator-activated protection and security features designed to assist users of MMP vehicles. In a non-limiting example, a mobile collision response feature may be a “hidden” background process that employs any one or more of the resident smartphone sensing, tracking, and measurement devices 70 to detect onset of a collision event. If applicable, the companion app 15 may automatically alert a first responder with real-time location data and collision event information. As another option, a roadside assistance feature enables riders with damaged or disabled MMP vehicles or in similar distress situations to request assistance (e.g., dispatch service personnel to charge a dead battery, change a flat tire, assist with a stolen scooter, etc.). An optional location status feature enables riders to view themselves and other riders on a live map, share and save locations, transmit/receive notifications when they/another rider depart for or arrive at a destination. When activated, the companion app 15 may operate as a standalone software engine to provide desired functionality or, alternatively, may pair with the MMP vehicle 10 via a suitable short-range communications protocol or plug-in connection to provide wireless connectivity, active sensing, automated vehicle response, and rider assistance capabilities for an MMP vehicle 10.

Activated at control operation (S2) is an integrated IAN component 17 app that operates within the companion app 15 and provisions vehicle warning and control features that are distinctively tailored to MMP vehicle-specific use cases. As will be explained in extensive detail below, for example, the IAN component 17 may offer scooter-specific terrain hazard notifications, alerts for motor vehicles in proximity to the scooter (e.g., approaching from behind), and warnings of scooter-specific distractions. The IAN component 17 leverages available MCP hardware and software to effectively transmute the smartphone 60 into an active sensor farm and advanced rider assistance system for an e-scooter 10 that may otherwise lack such functionality. IAN component 17 may also enable a rider 11 of an MMP vehicle 10 to wirelessly communicate with drivers and in-vehicle subsystems of nearby automobiles, e.g., to militate against a potential collision event.

Upon activation of the IAN component 17, the smartphone 10 executes control operation (S3) to automate a first-time aggregation of ambient condition data for the surrounding area proximal the MMP vehicle's present location or a user-selected start location. Ambient condition data may include ride-specific data that is retrieved from memory, third party resources, backend host services, MCD hardware/software, etc. IAN component 17 may pool open street map data, user-saved route data, and crowd-sourced geographic data (collectively “Terrain & Hazard Data’ 19) to identify—in addition to standard streets and roadways with associated dangers—sidewalks, alleys, and other pathways navigable via MMP vehicles and any hazards attendant thereto (collectively “Hazards Data” 21). The IAN component 17 may also prompt a third-party weather service 23 to provide weather forecasts, warnings of hazardous weather conditions, and other weather-related data (collectively “Weather/Climate Data” 25). In addition, the smartphone 60 may access a timed systems database 27 to pull historical or crowd-sourced lighting, irrigation, and gate systems information (collectively “Timed Systems Data” 29). A database may be maintained, e.g., via host cloud computing service 13, for any of the data sets based on previous geocoded riders or crowd-sourced riders and, if applicable, related inertial events.

After aggregating the first-time data retrieved at control operation (S3), the combined data is preprocessed, analyzed, and compared against available path plan data, including origin, destination, and predicted routing data, for the present trip of the MMP vehicle 10 in order to generate ride-specific recommendations at control operation (S4). Non-limiting examples of ride-specific recommendations may include presenting the user with an alternate route, a warning of an identified hazard or distraction, information specific to an identified hazard or distraction, etc. A ride-specific recommendation may be presented to the user via the e-scooter 10 (e.g., using display device 56), via the smartphone 60 (e.g., using touchscreen display device 66 or one of the output devices 68), or both. Notification thresholds and notification timing may be configured by a rider 11 through the companion app 15. For instance, the rider 11 may request to receive only audible and tactile notifications, and may request such notifications be generated and output within a predefined window of time (e.g., approximately three (3) seconds before an inertial event, such as a large bump in the sidewalk, or a friction risk event, such as a wet or water-pooled sidewalk). The companion app 15 may take into consideration scooter location, direction, speed, and (optionally) type to determine if/when to notify the rider 11.

In addition to presenting the rider 11 with ride-specific notifications related to predetermined hazards, weather conditions, and distractions, the smartphone 60 may also monitor the surrounding environment of the e-scooter 10 while en route to a desired destination to identify potential hazards and distractions in real-time or near real-time. At control operation (S5), for example, the IAN component 17 may first associate the rider 11 with one of a variety of predefined rider types (e.g., novice vs expert, aggressive vs conservative, etc.). Rider type information may be entered by the rider 11 or learned via the IAN component 17, e.g., using deep Neural Network learning techniques. Additional rider-specific information that may be collected at control operation (S5) includes a vehicle type (also referred to herein as “species”) and trim type (also referred to herein as “subspecies”). For MMP vehicle implementations, vehicle species may include e-scooters, e-bikes, e-skateboards, e-roller skates/blades, and a variety of other manually-powered vehicles with a resident motorized propulsion assist system. In this regard, vehicle subspecies may include “trim options” for the vehicle; for e-scooter applications, this may include standard, foldable, stunt, big wheel, and the like. By way of example, rider notifications, alerts, and warnings may be tailored differently for an expert rider on a competition class e-scooter with aggressive riding tendencies (e.g., using expert rider data 31) as opposed to an intermediate rider on a foldable e-bike with conservative riding tendencies (e.g., using standard rider data 33).

After identifying rider-specific data particular to the current operator 11 and the subject MMP vehicle 10, IAN component 17 begins to accumulate polling data to detect impending hazards and distractions along the upcoming path segments of the moving e-scooter 10, as indicated at control operation (S6). Polling data, such as expert-rider polled data 31 and standard-rider polled data 33 of FIG. 3, may be retrieved from participating crowd-sourced riders, collaborating proximal riders, resident sensing devices of the e-scooter 10, if any, and/or the sensing, tracking, and measurement devices 70 of the smartphone 60. Using crowd-sourced audio capture during an inertial event, for example, the IAN component 17 may detect an aggressive dog charging a fence adjacent one of the path segments along the rider's 11 current route. In another example, the companion app 15 may employ machine-learning object detection algorithms and a digital video camera of the smartphone 60 (e.g., when placed in the back pocket or backpack of the rider 11) as a smart rearview camera to detect an approaching vehicle overtaking the e-scooter 10. A collaborating rider, who is proximal to and ahead of the rider 11, may broadcast a warning to all nearby riders that a home-automated sprinkler systems is showering or has left puddles on one of the path segments along the rider's 11 current route.

At control operation (S7), the IAN component 17 preprocesses and analyzes the polling data collected at control operation (S6), independently or in combination with the first-time data aggregated at control operation (S3), to generate and output ride-and-rider specific notifications. Non-limiting examples of rider-and-ride specific notifications may include presenting the user with a warning to avoid the current route, a warning of an upcoming hazard or distraction, information specific to an upcoming hazard or distraction, a warning to allow an approaching automobile to overtake and pass the e-scooter 10, etc. With the handheld MCD 60 in the rider's back pocket and the camera facing rearward, for example, the IAN component 17 may detect an automobile approaching from behind; a haptic transducer resident to the device 60 may issue a single “alert” vibration notifying of the automobile's presence or, when appropriate, a series of vibrations with progressively increasing intensity/duty cycle to indicate a more complex notification of distance and target confidence. As another option, the IAN component 17 may leverage the smartphone's Bluetooth connectivity to activate one or more LEDs or haptic feedback devices on the handlebars of the e-scooter 10. Other options may include using multiple sensors and output devices to indicate a side of approach, a speed of approach, a size of the approaching vehicle, a proximity of the approaching vehicle, etc.

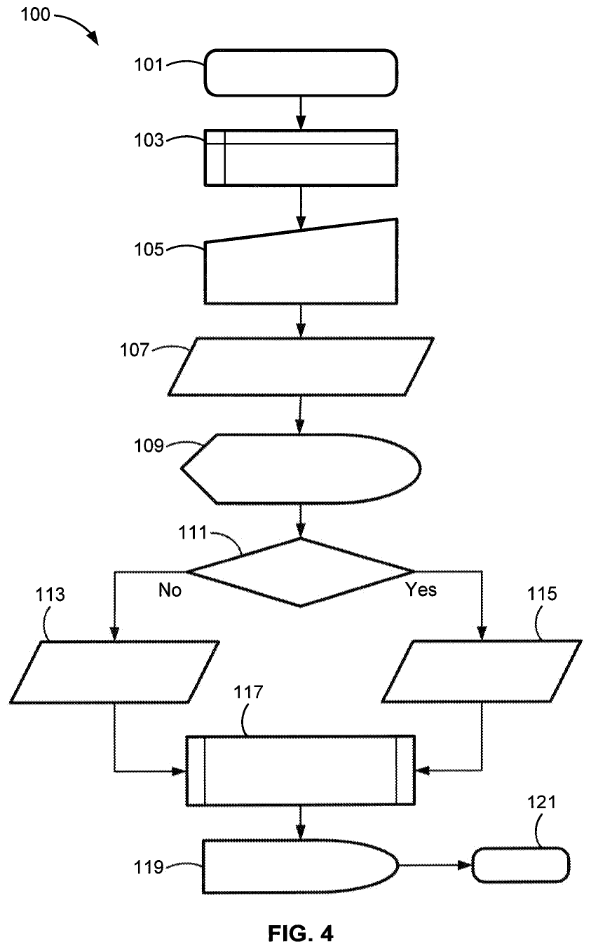

With reference next to the flow chart of FIG. 4, an improved method or control strategy for assisting a vehicle operator, such as rider 11 of FIG. 3, with operating a motor-assisted, manually powered vehicle, such as e-scooter 10 of FIGS. 1 and 2, is generally described at 100 in accordance with aspects of the present disclosure. Some or all of the operations illustrated in FIG. 4, and described in further detail below, may be representative of an algorithm that corresponds to processor-executable instructions that are stored, for example, in main or auxiliary or remote memory, and executed, for example, by an electronic controller, processing unit, logic circuit, or other module or device or network of modules/devices, to perform any or all of the above and below described functions associated with the disclosed concepts. It should be recognized that the order of execution of the illustrated operation blocks may be changed, additional operation blocks may be added, and some of the described operations may be modified, combined, or eliminated.

Method 100 begins at terminal block 101 with memory-stored, processor-executable instructions for a programmable controller or control module or similarly suitable processor to call up an initialization procedure for an adaptive rider assistance protocol, such as companion app 15 of FIG. 3. This routine may be executed in real-time, near real-time, continuously, systematically, sporadically, and/or at regular time intervals, for example, each 10 or 100 milliseconds during normal and ongoing operation of the host MMP vehicle. As yet another option, terminal block 101 may initialize responsive to a user command prompt, a resident vehicle controller prompt, or a broadcast prompt signal received from an “off-board” centralized vehicle services system (e.g., host cloud computing service 13). Upon completion of the control operations presented in FIG. 4, the method 100 may advance to terminal block 121 and temporarily terminate or, optionally, may loop back to terminal block 101 and run in a continuous loop.

After initializing the companion application at terminal block 101, method 100 advances to internal storage (RAM) process block 103 to activate a scooter-centric component, such as IAN component 17 of FIG. 3, that is operating within the companion application. From there, the method 100 executes data input process block 105 to collect path plan data specific to the current ride of the vehicle operator on the MMP vehicle. Touchscreen display device 66, alone or in cooperation with one or more of the sensing, tracking, and measurement devices 70, may receive or retrieve path plan data from the rider and/or a location tracking service (e.g., a GPS transceiver). This path plan data may include a current location or a desired start location (vehicle origin), a predicted terminus or a selected end point (vehicle destination), and an estimated or selected route (predicted path) for the MMP vehicle. At this juncture, the companion application operating on the handheld MCD may identify an appropriate species and subspecies for the MMP vehicle (e.g., e-scooter with all-terrain big wheels and high-output electric MGU), derive a user skill level for the operator of the MMP vehicle (e.g., expert), and process one or more user-selected preferences that have been input by the MMP vehicle operator (e.g., degree of motor assist preference, notification type and timing preference, hazards to ignore, etc.).

At data input/output process block 107, method 100 uses the received path plan data to determine MMP-specific ambient data that is proximal to the vehicle origin and/or aligned along a predefined segment or segments of the predicted path. MMP-specific ambient data contains one or more predefined sets of surrounding environment data, each of which is tailored to the vehicle type/species of the MMP vehicle. By way of example, and not limitation, one predefined set of surrounding environment data may contain memory-stored hazards that are proximal to the e-scooter's current location or located on the predicted path and predetermined to be potentially detrimental to MMP vehicles. One predefined set of surrounding environment data may contain weather data that is indicative of ambient weather conditions proximal the vehicle origin/path and predetermined to be unfavorable or potentially injurious to riders of MMP vehicles. Another predefined set of surrounding environment data may contain timed systems data that is indicative of home-automated irrigation, lighting, door and gate systems, etc., proximal the vehicle origin/path and predetermined to be distracting or potentially dangerous to riders of MMP vehicles. In addition to MMP-specific ambient data, the companion application may also retrieve user-saved historical trip data, real-time geolocation data, open street map data, crowd-sourced data, etc. Using this data, ride-specific recommendations, such as those described above with reference to control operation (S4) of FIG. 3, may be presented to the user at data output (display) block 109.

Advancing to decision block 111, the MMP-vehicle tailored component within the companion app determines if the skill level of the current operator of the subject MMP vehicle is an expert. As explained above, additional and alternative metrics may be considered at this juncture when determining the types of data that will be collected and evaluated when presenting alerts and notifications to riders. If the current rider is not an expert (block 111=NO), method 100 may poll “live” real-time data for riders having an intermediate or novice skill level at data input/output block 113. Conversely, if the current operator is an expert rider (block 111=YES), method 100 may poll “live” real-time data for riders having an expert skill level at data input/output block 115.

With continuing reference to FIG. 4, method 100 moves from data input/output block 113 or 115 to predefined process block 117 to analyze the polling data and determine if there are any hazards, distractions or motorized vehicles that pose a threat to the MMP vehicle as it traverses from the vehicle origin to the vehicle destination. To that end, a wireless location device resident to the handheld MCD may track the real-time location of the MMP vehicle while traversing from the vehicle origin to the vehicle destination. While tracking the vehicle location, one or more sensing devices resident to the handheld MCD attempt to identify MMP-specific threats that are aligned with the real-time vehicle location. MMP-specific threat data may contain one or more predefined sets of user danger data that is tailored to the designated species of the MMP vehicle. One of these predefined sets of user danger data may contain hazards data that is indicative of detected hazards along the vehicle path and proximal the real-time vehicle location. Another set of user danger data may contain approaching vehicles data that is indicative of one or more detected motor vehicles that are approaching the real-time vehicle location. As yet another example, a predefined set of user danger data may contain distractions data that is indicative of a detected user distraction that is specific to MMP vehicles and proximal the real-time vehicle location.

Advancing from predefined process block 117, method 100 executes data output (display) block 119 in order to present the rider-and-ride specific notifications to the current operator of the MMP vehicle. For instance, the handheld MCD may transmit one or more command signals to a resident vehicle subsystem, such as touchscreen interactive display device 56 and/or an array of LEDs or haptic transducers mounted to the MMP vehicle, to execute one or more control operations based on the MMP-specific ambient data and/or the MMP specific threat data. As noted above, the resident vehicle subsystem may take on a variety of different forms, including audio components, video components, touch-sensitive components, etc., that singly or collectively produce audible/visual/tactile feedback to a user of the MMP. In addition, or alternatively, the handheld MCD may transmit one or more wireless signals to an approaching vehicle; the motor vehicle may responsively activate a resident vehicle subsystem in order to alert the driver or other vehicle occupant as to the presence, location, speed, trajectory, etc., of the MMP vehicle. Each control operation may be selectively modified based, for example, on the vehicle subspecies of the MMP vehicle, the user skill level of the operator, and/or any received user-selected preferences.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a motor-assisted manually powered (MMP) vehicle using a handheld mobile computing device (MCD), the method comprising:
receiving, via the handheld MCD, path plan data including a vehicle origin for the MMP vehicle;
determining, via the handheld MCD based on the received path plan data, MMP-specific ambient data aligned with the vehicle origin and containing a predefined set of surrounding environment data particular to a vehicle species of the MMP vehicle;
tracking, via a wireless location device of the handheld MCD, a real-time vehicle location of the MMP vehicle while traversing from the vehicle origin to a vehicle destination;
detecting, via a sensing device of the handheld MCD, MMP-specific threat data aligned with the real-time vehicle location and containing a predefined set of user danger data particular to the vehicle species of the MMP vehicle; and
transmitting, via the handheld MCD to a resident vehicle subsystem attached to the MMP vehicle, a command signal to execute a control operation based on the MMP-specific ambient data and/or the MMP specific threat data.

2. The method of claim 1, further comprising:
determining, via the handheld MCD, a vehicle subspecies of the MMP vehicle; and
modifying the control operation based on the vehicle subspecies of the MMP vehicle.

3. The method of claim 1, further comprising:
determining, via the handheld MCD, a user skill level specific to an operator of the MMP vehicle, and
modifying the control operation based on the user skill level of the operator.

4. The method of claim 1, further comprising:
receiving, via a human-machine interface (HMI) of the handheld MCD, a user-selected preference input by an operator of the MMP vehicle; and
modifying the control operation based on the user-selected preference.

5. The method of claim 1, wherein the sensing device of the handheld MCD includes a video camera and/or a proximity sensor, and wherein the predefined set of user danger data includes target object data indicative of a motor vehicle approaching the MMP vehicle.

6. The method of claim 5, further comprising transmitting, via the handheld MCD to a motor vehicle subsystem of the motor vehicle, a notification alerting a driver to a presence of the MMP vehicle relative to the motor vehicle.

7. The method of claim 1, wherein the path plan data further includes a predicted path from the vehicle origin to the vehicle destination, and wherein the predefined set of surrounding environment data includes a memory-stored hazard located on the predicted path, the method further comprising determining, via the handheld MCD, an alternate route for traversing from the vehicle origin to the vehicle destination.

8. The method of claim 1, wherein the resident vehicle subsystem includes an audio device, a video device, and/or a tactile device mounted to a vehicle body of the MMP vehicle, and wherein the control operation includes an audible, visual, or tactile notification.

9. The method of claim 1, further comprising outputting, to a user of the MMP vehicle via an audio device and/or a tactile device of the handheld MCD, an audible or tactile notification based on the MMP-specific ambient data and/or the MMP specific threat data.

10. The method of claim 1, wherein the predefined set of surrounding environment data of the MMP-specific ambient data includes hazards data indicative of path hazards proximal the vehicle origin, weather data indicative of ambient weather conditions proximal the vehicle origin, and/or timed systems data indicative of home-automated irrigation, lighting and/or door systems proximal the vehicle origin.

11. The method of claim 1, wherein the predefined set of user danger data of the MMP-specific threat data includes hazards data indicative of detected path hazards proximal the real-time vehicle location, approaching vehicles data indicative of a detected motor vehicle approaching the real-time vehicle location, and/or distractions data indicative of a detected one of a plurality of preset user distractions proximal the real-time vehicle location.

12. The method of claim 1, wherein the handheld MCD includes a smartphone, and the sensing device includes an accelerometer, a gyroscope, a proximity sensor, a magnetometer, a temperature sensor, a global positioning system transceiver, and/or a light sensor.

13. The method of claim 1, wherein the vehicle species of the MMP vehicle includes an electric pedal cycle, an electric standing kick scooter, or an electric skateboard each equipped with a motor operable to generate intermittent assist torque to propel the MMP vehicle.

14. A motor-assisted manually powered (MMP) vehicle, comprising:
a vehicle body with a platform configured to support thereon a user;
a plurality of road wheels attached to the vehicle body;
a motor attached to the vehicle body and operable to drive one or more of the road wheels and thereby assist with propelling the MMP vehicle concurrent with manual propulsion via the standing user;
a vehicle controller attached to the vehicle body and configured to communicate with a handheld mobile computing device (MCD) carried by the standing user; and
a dedicated mobile software application executable on the handheld MCD and programmed to:
receive path plan data including a vehicle origin for the MMP vehicle;
receive, based on the received path plan data, MMP-specific ambient data aligned with the vehicle origin and containing a predefined set of surrounding environment data particular to a vehicle species of the MMP vehicle;
track, using a wireless location device of the handheld MCD, a real-time vehicle location of the MMP vehicle while traversing from the vehicle origin to a vehicle destination;
detect, using a sensing device of the handheld MCD, MMP-specific threat data aligned with the real-time vehicle location and containing a predefined set of user danger data particular to the vehicle species of the MMP vehicle; and
transmit, to the vehicle controller for execution via a resident vehicle subsystem mounted to the MMP vehicle, a command signal to execute a control operation based on the MMP-specific ambient data and/or the MMP specific threat data.

15. A non-transitory, computer-readable medium (CRM) storing instructions executable by one or more processors of a handheld mobile computing device (MCD) to operate a motor-assisted manually powered (MMP) vehicle, the instructions, when executed by the one or more processors, causing the handheld MCD to perform operations comprising:
receiving path plan data including a vehicle origin for the MMP vehicle;
determining, based on the received path plan data, MMP-specific ambient data aligned with the vehicle origin and containing a predefined set of surrounding environment data particular to a vehicle species of the MMP vehicle;
tracking, using a wireless location device of the handheld MCD, a real-time vehicle location of the MMP vehicle while traversing from the vehicle origin to a vehicle destination;
detecting, using a sensing device of the handheld MCD, MMP-specific threat data aligned with the real-time vehicle location and containing a predefined set of user danger data particular to the vehicle species of the MMP vehicle; and
transmitting a command signal to a resident vehicle subsystem of the MMP vehicle to execute a control operation based on the MMP-specific ambient data and/or the MMP specific threat data.

16. The CRM of claim 15, wherein the operations further comprise:
determining a vehicle subspecies of the MMP vehicle; and
modifying the control operation based on the vehicle subspecies of the MMP vehicle.

17. The CRM of claim 15, wherein the operations further comprise:
determining a user skill level specific to an operator of the MMP vehicle; and
modifying the control operation based on the user skill level of the operator.

18. The CRM of claim 15, wherein the operations further comprise:
receiving, via a human-machine interface (HMI) of the handheld MCD, a user-selected preference input by an operator of the MMP vehicle; and
modifying the control operation based on the user-selected preference input by the operator.

19. The CRM of claim 15, wherein the sensing device of the handheld MCD includes a video camera and/or a proximity sensor, and wherein the predefined set of user danger data includes target object data indicative of a motor vehicle approaching the MMP vehicle.

20. The CRM of claim 15, wherein the path plan data further includes a predicted path from the vehicle origin to the vehicle destination, wherein the predefined set of surrounding environment data includes a memory-stored hazard located on the predicted path, and wherein the operations further comprise determining an alternate route for traversing from the vehicle origin to the vehicle destination.
